(19) United States
(12) Patent Application Publication
(10) Pub. No.: US 2007/0080475 A1
(43) Pub. Date: Apr. 12, 2007

(54) Manufacturing method for EVA foam body

(76) Inventor: Hui Li Wang, Taichung (TW)

Correspondence Address: WANG HUI LI, P.O. BOX 2103, TAICHUNG, TW

(21) Appl. No.: 11/246,057

(22) Filed: Oct. 11, 2005

(51) Int. Cl. B29C 59/04

(52) U.S. Cl. 264/129; 264/321; 264/322; 264/284

(57) ABSTRACT

A manufacturing method for EVA foam body, including steps of: by means of intaglio printing, printing an ink stripe layer onto a plane surface of a board-like EVA foam body; drying the ink stripe layer; heating the EVA foam body to soften the plane surface with the ink stripe layer; and immediately using a low-temperature roller to roll the EVA foam body for solidifying and notching/embossing the surface.

### BACKGROUND OF THE INVENTION

The present invention is related to a manufacturing method for EVA (Ethylene Vinyl Acetate) foam body. A surface of a board-like EVA foam body is heated and softened and then a low-temperature roller is used to roll the EVA foam body for solidifying and notching/embossing the surface. In addition, an ink stripe layer is printed onto the surface of the board-like EVA foam body.

Many floor tiles, jigsaw puzzles and decorations are made of EVA foam bodies. These foam bodies are often printed with ink figures for beautifying the appearance.

FIG. 4 shows an existent method for manufacturing EVA foam body. The EVA material 7 is foamed and molded with a mold. Then the EVA material 7 is cut along a middle line 71 into an upper sheet of EVA foam body 70 and a lower sheet of EVA foam body 70. Then a thermal roller 61 is used to roll a transfer printing membrane 62, making the ink figures 621 thereof attach to a surface 701 of the EVA foam body 70. When molded, the surface of the EVA foam body 70 is simultaneously embossed with stripes for achieving slip proof effect. Therefore, it is hard for the ink figures 621 to firmly attach to the surface. However, in comparison with the cut face 702 of the EVA foam body 70, the embossed surface 701 has smaller foam pores and is planer. Therefore, it is not considered to transfer print the ink figures 621 onto the cut surface 702. Furthermore, before transfer printing the ink figures 621 onto the surface of the EVA foam body 70, it is necessary to clean the surface of the EVA foam body 70 for more reliably attaching the ink figures 621 onto the surface of the EVA foam body 70. Moreover, the manufacturing cost for the transfer printing membrane is high and it is necessary to previously manufacture and store the transfer printing membrane. In addition, it takes long time to foam the EVA material. Each time only two sheets of EVA foam bodies are formed with one mold. The production capacity is limited.

FIG. 5 shows an improved manufacturing method for overcoming the above problems. The EVA material is foamed and molded with a mold into a block body 8. Then the block body 8 is transversely cut into several EVA foam bodies 80. Then the surface of the EVA foam body 80 is heated and softened with hot wind 91. Finally, a roller 92 is used to roll the transfer printing membrane 93, making the ink figures 931 thereof attach to the surface 801 of the EVA foam bodies 80. At the same time, by means of the notched stripes 921 of the surface of the roller, the surface of the EVA foam bodies 80 is formed with notched stripes.

According to the above manufacturing procedure, each time the block body 8 can be cut into several sheets of EVA foam bodies. Therefore, the production capacity is several times enhanced. However, the transfer printing membrane is still needed for forming the ink figures on the foam body. Therefore, the cost for previously manufacturing and storing the transfer printing membranes still cannot be saved

### SUMMARY OF THE INVENTION

It is therefore a primary object of the present invention to provide a manufacturing method for EVA foam body, in which an ink stripe layer is printed onto the surface of the EVA foam body instead of transfer printing membrane. Therefore, the cost for the transfer printing membrane can be saved. In addition, it is unnecessary to previously manufacture and store the transfer printing membrane.

It is a further object of the present invention to provide the above manufacturing method for EVA foam body, by which the ink stripe layer can more firmly attach to the surface of the EVA foam body and the pores of the surface of the EVA foam body can be planed to smoothen the surface of the EVA foam body.

According to the above objects, the manufacturing method for EVA foam body includes steps of: by means of intaglio printing, printing an ink stripe layer onto a plane surface of a board-like EVA foam body; drying the ink stripe layer; heating the EVA foam body to soften the plane surface with the ink stripe layer; and immediately using a low-temperature roller to roll the EVA foam body for solidifying and notching/embossing the surface.

The present invention can be best understood through the following description and accompanying drawings wherein:

### BRIEF DESCRIPTION OF THE DRAWINGS

FIG. 1 is a flow chart of the manufacturing method of the present invention;

FIG. 2 is a sectional view of the EVA foam body manufactured by the manufacturing method of the present invention;

FIG. 3 is a flow chart of another embodiment of the manufacturing method of the present invention;

FIG. 4 is a flow chart of a conventional manufacturing method for EVA foam body; and

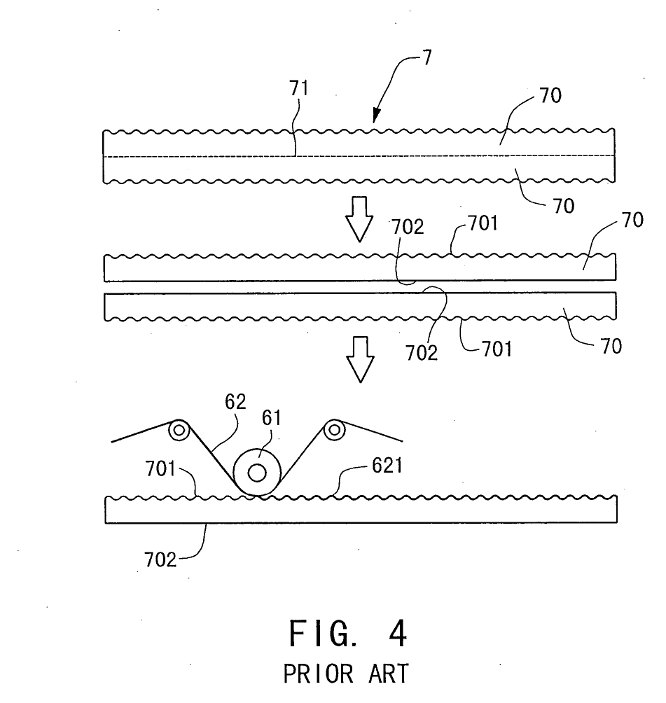

FIG. 5 is a flow chart of another conventional manufacturing method for EVA foam body.

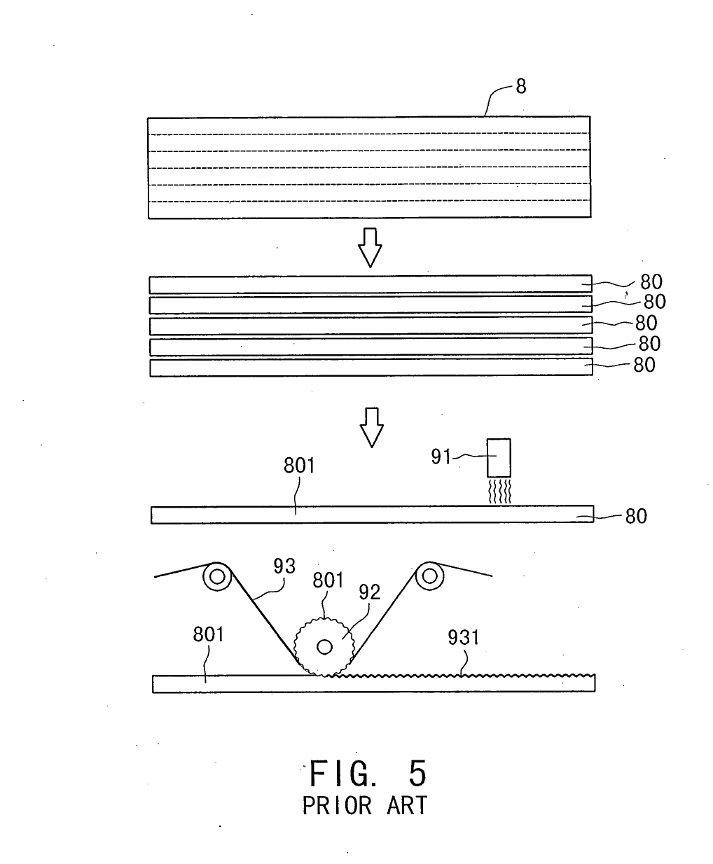

### DETAILED DESCRIPTION OF THE PREFERRED EMBODIMENTS

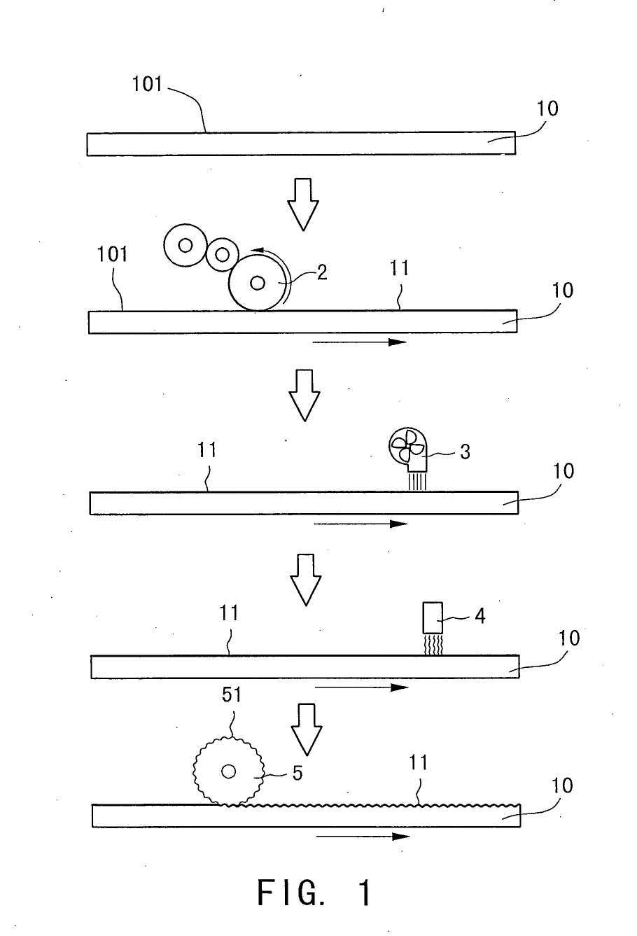

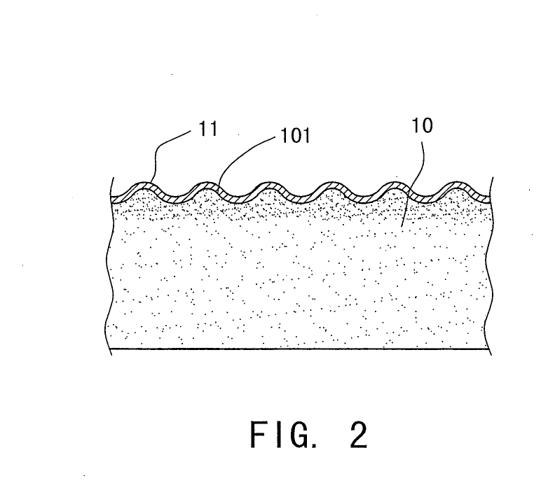

Please refer to FIG. 1. The manufacturing method for EVA foam body of the present invention includes steps of:
(a) preparing a board-like EVA foam body 10 with at least one plane surface;
(b) forming an intaglio printing plate (or embossed printing plate) on a surface of a roller 2 and printing ink onto the surface 101 of the EVA foam body 10 by means of intaglio printing print to form an ink stripe layer 11 on the surface of the EVA foam body 10;
(c) blowing wind 3 onto the ink stripe layer 11 to quickly dry the ink stripe layer 11;
(d) blowing hot wind 4 within 100° C.˜250° C. onto the surface 101 of the EVA foam body 10 with the ink stripe layer to heat the same and soften the plane surface 101; and
(e) immediately next to step (d), using a low-temperature roller 5 to roll the EVA foam body 10, in which a coolant circulates in the low-temperature roller 5 to maintain the temperature of the surface of the roller 5, the surface of the roller 5 being formed with notched/embossed stripes 51, whereby the surface 101 is solidified and notched/embossed as shown in FIG. 2.

The advantages of the above manufacturing method are as follows:
1. The intaglio printing plate formed on the surface of the roller 2 can be designed with necessary figures. More importantly, the printing operation is directly done to the EVA foam body so that the cost for the transfer printing membrane can be saved. In addition, it is unnecessary to previously manufacture and store the transfer printing membrane.
2. In the case that it is desired to form a multicolored figure, steps (b) and (c) can be repeatedly continuously performed to form a multicolored ink stripe layer, that is, a number of rollers can be prepared according to the colors of the inks and the inks can be dried several times to form the colorful ink stripe layer.
3. The hot wind is blown onto the plane surface of the EVA foam body to soften the plane surface for more firmly attaching the ink stripe layer to the EVA foam body. Therefore, it is unnecessary to previously clean the surface of the EVA foam body before printed. Also, when the low-temperature roller rolls the EVA foam body, the surface thereof is forcedly plastically notched/embossed to form stripes complementary to the notched/embossed stripes of the surface of the low-temperature roller. In addition, the low-temperature roller quickly cools and solidifies the plane surface.
4. After the surface of the EVA foam body is plastically rolled and notched/embossed by the low-temperature roller, the pores of the EVA foam body are pressed and planed to smoothen and beautify the surface. Accordingly, in step (a), the EVA material can be foamed and molded into a block body in a mold and then the block body is cut into several sheets of EVA foam bodies. That is, the cut surface of the sliced board-like EVA foam body will have pores larger than the pores of the surface of the EVA foam body after foamed. However, the pores of the cut surface of the EVA foam body can be still pressed and planed after rolled by the low-temperature roller.
5. Steps (a) to (e) can be continuously completed with the same manufacturing equipment so that the production efficiency can be effectively enhanced.

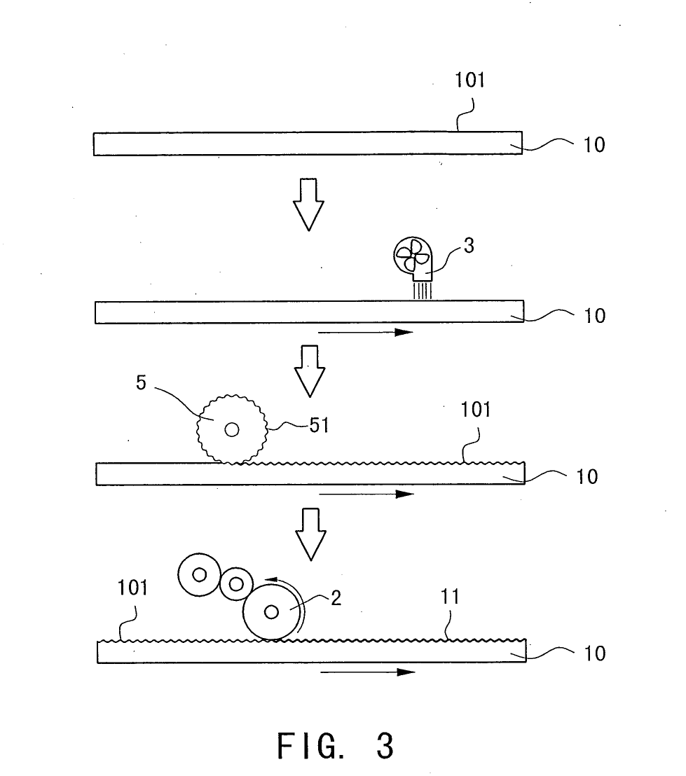

FIG. 3 shows a second embodiment of the manufacturing method for EVA foam body of the present invention, including steps of:
(a) preparing a board-like EVA foam body 10 with at least one plane surface;
(b) blowing hot wind 4 within 100° C.˜250° C. onto the plane surface 101 of the EVA foam body to soften the plane surface 101;
(c) immediately next to step (b), using a low-temperature roller 5 to roll the EVA foam body, in which a coolant circulates in the low-temperature roller 5 to maintain the temperature of the surface of the roller 5, the surface of the roller 5 being formed with notched/embossed stripes 51, whereby the surface 101 is solidified and notched/embossed;
(d) forming an intaglio printing plate on a surface of a roller 2 and printing ink onto the notched/embossed surface 101 of the EVA foam body 10 by means of intaglio printing print to form an ink stripe layer 11 on the surface 101 of the EVA foam body 10; and
(e) blowing wind 3 onto the ink stripe layer 11 to quickly dry the ink stripe layer 11.

The second embodiment can achieve the same effects as the first embodiment. Only the sequence of the steps is slightly different.

The above embodiments are only used to illustrate the present invention, not intended to limit the scope thereof. Many modifications of the above embodiments can be made without departing from the spirit of the present invention.

What is claimed is:

1. A manufacturing method for EVA (Ethylene Vinyl Acetate) foam body, comprising steps of:
(a) preparing a board-like EVA foam body with at least one plane surface;
(b) printing an ink stripe layer on the plane surface of the EVA foam body;
(c) drying the ink stripe layer;
(d) heating the EVA foam body to soften the plane surface with the ink stripe layer; and
(e) immediately next to step (d), using a low-temperature roller to roll the softened surface of the EVA foam body, whereby the softened surface is solidified and notched/embossed.

2. The manufacturing method for EVA foam body as claimed in claim 1, wherein in step (b), an intaglio printing plate is formed on a surface of a roller for printing ink onto the plane surface of the EVA foam body, whereby an ink stripe layer corresponding to the intaglio printing plate of the roller is formed on the plane surface of the EVA foam body.

3. The manufacturing method for EVA foam body as claimed in claim 2, wherein in step (c), wind blows onto the ink stripe layer to dry the same.

4. The manufacturing method for EVA foam body as claimed in claim 3, wherein in step (d), hot wind within 100° C.˜250° C. blows onto the plane surface of the EVA foam body to heat and soften the plane surface.

5. The manufacturing method for EVA foam body as claimed in claim 4, wherein in step (e), the surface of the low-temperature roller is formed with notched/embossed stripes and a coolant circulates in the low-temperature roller to maintain the temperature of the surface of the low-temperature roller.

6. The manufacturing method for EVA foam body as claimed in claim 1 or 5, wherein steps (b) and (c) are repeatedly continuously performed to form a multicolored ink stripe layer.

7. A manufacturing method for EVA foam body, comprising steps of:
(a) preparing a board-like EVA foam body with at least one plane surface;
(b) heating the EVA foam body to soften the plane surface thereof;
(c) immediately next to step (b), using a low-temperature roller to roll the plane surface of the EVA foam body, whereby the plane surface is solidified and notched/embossed;
(d) by means of intaglio printing, printing an ink stripe layer onto the plane surface of the EVA foam body rolled in step (c); and
(e) drying the ink stripe layer.

8. The manufacturing method for EVA foam body as claimed in claim 7, wherein in step (b), hot wind within 100° C.˜250° C. blows onto the plane surface of the EVA foam body to heat and soften the plane surface.

9. The manufacturing method for EVA foam body as claimed in claim 8, wherein in step (c), the surface of the low-temperature roller is formed with notched/embossed stripes and a coolant circulates in the low-temperature roller to maintain the temperature of the surface of the low-temperature roller.

10. The manufacturing method for EVA foam body as claimed in claim 9, wherein in step (d), an intaglio printing plate is formed on a surface of a roller for printing ink onto the plane surface of the EVA foam body, whereby an ink stripe layer corresponding to the intaglio printing plate of the roller is formed on the plane surface of the EVA foam body.

11. The manufacturing method for EVA foam body as claimed in claim 10, wherein in step (e), wind blows onto the ink stripe layer to dry the same.

12. The manufacturing method for EVA foam body as claimed in claim 7 or 11, wherein steps (d) and (e) are repeatedly continuously performed to form a multicolored ink stripe layer.
